(19) United States
(12) Patent Application Publication
(10) Pub. No.: US 2010/0318666 A1
(43) Pub. Date: Dec. 16, 2010

(54) EXPEDITING ADAPTER FAILOVER

(75) Inventors: James R. Gallagher, Austin, TX (US); Binh Hua, Austin, TX (US); Hong L. Hua, Austin, TX (US); Wen Xiong, Austin, TX (US)

Correspondence Address: IBM CORPORATION (JSS);C/O SCHUBERT LAW GROUP PLLC, 6013 CANNON MOUNTAIN DRIVE, S14, AUSTIN, TX, 78749, US

(73) Assignee: International Business Machines Corporation, Armonk, NY (US)

(21) Appl. No.: 12/481,663

(22) Filed: Jun. 10, 2009

(51) Int. Cl. G06F 15/173; G06F 9/44

(52) U.S. Cl. 709/228; 719/328

(57) ABSTRACT

Expediting adapter failover may minimize network downtime and preserve network performance. Embodiments may comprise copying a primary adapter memory of a failing primary adapter to a standby adapter memory of a standby adapter. Copying the memory may expedite TCP/IP offload adapter failover by maintaining TCP/IP stack and connection information. In several embodiments, Copy Logic may copy primary adapter memory to standby adapter memory. In some embodiments, Detect Logic may monitor primary adapter viability and may initiate failover. In additional embodiments, Assess Logic may assess whether the IO bus is operative permitting Direct Logic to copy adapter memory via, e.g., DMA. In other embodiments, Packet Logic may fragment primary adapter memory into network packets sent through the network to the standby adapter where Unpack Logic may unpack them into memory.

### BACKGROUND

Local area networks (LAN) occupy discrete physical areas as compared to wide-area networks (WAN) covering extensive geographical areas as exemplified by the Internet. TCP/IP is a communications protocol utilized by LANs and WANs as well as the Internet which is the largest TCP/IP network. An increasing number of native host functions, including TCP/IP (Transmission Control Protocol/Internet Protocol), are offloaded to IO (input-output) adapters. Offloading relieves host CPU (Central Processing Unit) workload and has the added benefit of improving IO adapter throughput.

### SUMMARY

One embodiment provides an apparatus for a Setup Logic coupled with a primary adapter memory of a primary adapter to interconnect a computer to a network; the Setup Logic to store a network address in a memory location of the primary adapter memory and in a memory location of a standby adapter memory of a standby adapter; and a Copy Logic coupled with the primary adapter memory, the Copy Logic to copy, during failover, a content of the primary adapter memory to the standby adapter memory at the network address stored in the memory location, wherein the content comprises a portion of the primary adapter memory with connection information for establishing connections in the standby adapter memory.

Another embodiment provides a method for copying adapter memory during failover. The method generally may include detecting, by a Detect Logic, deterioration of a primary adapter connected to a network to establish connections with other devices; notifying, by the Detect Logic, an Assess Logic to begin failover in response to detecting deterioration of the primary adapter; determining, by the Assess Logic, a method of copying a content of the primary adapter memory to a standby adapter memory of a standby adapter; and copying, by a Copy Logic, the content of the primary adapter memory to the standby adapter memory at a network address stored in a memory location, wherein the content comprises a portion of the primary adapter memory with connection information to establish connections in the standby adapter memory.

Another embodiment provides for a failover system. The failover system contemplates a standby adapter, with a standby adapter memory; and a primary adapter to interconnect a computer to a network, having a primary adapter memory, the primary adapter to failover to the standby adapter in response to primary adapter deterioration, by copying a content of the primary adapter memory to the standby adapter memory, wherein the content comprises a portion of the primary adapter memory with connection information for establishing connections in the standby adapter memory.

### BRIEF DESCRIPTION OF THE DRAWINGS

FIG. 1 illustrates an embodiment of a LAN utilizing a failover adapter;

FIG. 2 depicts a block diagram of an embodiment of certain components of a personal computer including a failover adapter;

FIG. 3 depicts flowcharts of embodiments illustrating setup of a Destination Memory Location (DML) hardware register and a Remote MAC Address (RMA) hardware register;

FIG. 4 depicts a flowchart of an embodiment illustrating adapter failover;

FIG. 5 depicts a flowchart of an embodiment illustrating failover from the perspective of an Adapter A; and

FIG. 6 depicts a flowchart of an embodiment illustrating failover from the perspective of an Adapter B.

### DETAILED DESCRIPTION

The following is a detailed description of novel embodiments depicted in the accompanying drawings. However, the amount of detail offered is not intended to limit anticipated variations of the described embodiments; on the contrary, the claims and detailed description are to cover all modifications, equivalents, and alternatives falling within the spirit and scope of the present teachings as defined by the appended claims.

The detailed descriptions below are designed to make such embodiments understandable to a person having ordinary skill in the art. Embodiments may comprise logic such as hardware and/or code. While some of the specific embodiments described below reference embodiments with specific configurations, those of skill in the art will realize that embodiments of the present disclosure may be implemented with other configurations with similar issues or problems.

Generally, this disclosure describes embodiments for expediting offload adapter failover. Expediting adapter failover may minimize network downtime and preserve network performance. In many embodiments, copying a primary adapter memory of a failing primary adapter to a standby adapter memory of a standby adapter may expedite TCP/IP offload adapter failover by maintaining TCP/IP stack and connection information.

In some embodiments, TCP/IP stack and connection information may travel through an IO bus. In other embodiments, TCP/IP stack and connection information may travel through a network media. Regardless of the transport method, a network address may provide guidance indicating where to transport the information for storage in the standby adapter. In multiple embodiments, the network address may comprise a memory address or a MAC address (Media Access Control address of a network adapter).

In several embodiments, an Assess Logic may determine status of the IO bus to ascertain whether DMA (direct memory access) is possible. An operative IO bus may permit DMA which is the swiftest avenue for adapter memory copying. DMA allows CPU independent data transmission from memory to memory such that an adapter may access memory directly. In many embodiments, a Copy Logic may comprise a Direct Logic for copying adapter memory via DMA.

However, an inoperative IO bus may prohibit DMA necessitating memory transfer through the network. In multiple embodiments, Copy Logic may comprise a Packet Logic and an Unpack Logic. More specifically, a Packet Logic may fragment primary adapter memory, pack the fragmented memory into network packets, and send the network packets through the network. The network packets may travel through the network to the standby adapter where Unpack Logic may recognize the network packets and unpack the fragmented memory into the standby adapter memory.

In several embodiments, a Setup Logic may setup the Destination Memory Location (DML) hardware register and the Remote MAC Address (RMA) hardware register for storing a network address which may be a memory address or a MAC address or both. In several embodiments, the Destination Memory Location (DML) hardware register may store the memory address which is the destination of adapter memory copied via DMA whereas the Remote MAC Address (RMA) hardware register may store the MAC address to which the fragmented adapter memory network packets may be sent.

In numerous embodiments, high performance network adapters offering TCP/IP offload may incorporate expedited offload adapter failover. In several embodiments, the adapter may comprise a TOE adapter (TCP/IP Offload Engine) for offloading TCP/IP stack processing. In further embodiments, the adapter may comprise an iSCSI adapter (Internet Small Computer System Interface), a protocol serializing SCSI (Small Computer System Interface) commands for conversion to TCP/IP. In several embodiments, the adapter may comprise an RNIC (RDMA network interface card) adapter which is an RDMA enabled adapter (Remote Direct Memory Access, CPU independent data transmission from memory to memory). In some embodiments, the adapter may comprise an iWRAP adapter (Internet Wireless Router Application Platform, single board computer format). In additional embodiments, the adapter may comprise a Fibre Channel adapter which is a high performance network adapter participating in building SANS (storage area networks).

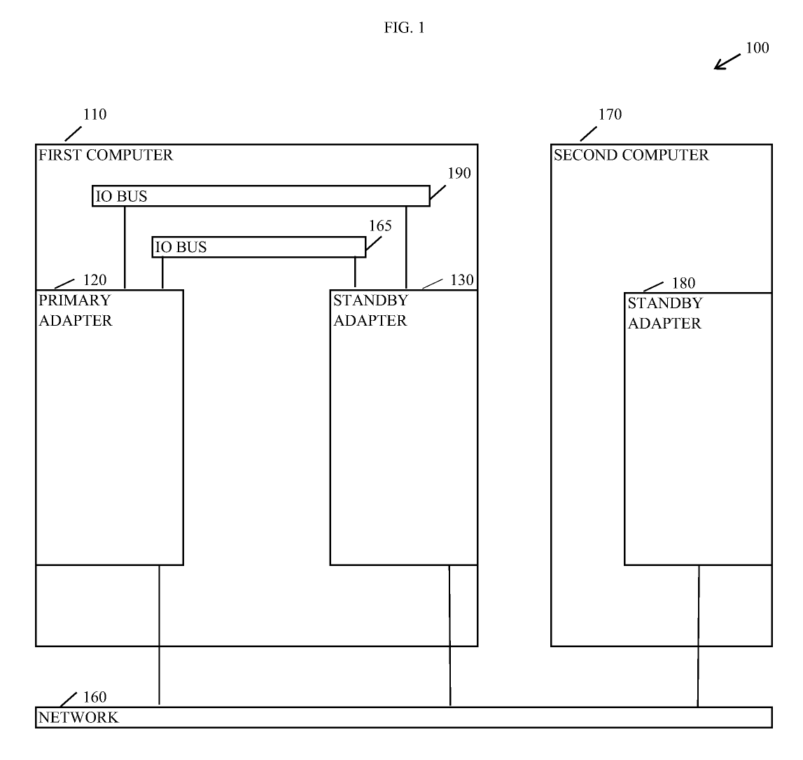

With reference now to the drawings, FIG. 1 illustrates an embodiment of a failover system 100. The failover system 100 may comprise a first computer 110, a network 160, and a remote second computer 170. The first computer 110 may be connected with the second computer 170 by, e.g., a TCP/IP network. Network 160 may comprise a local area network (LAN), a wide area network (WAN), a metropolitan area network (MAN), a combination thereof, or a combination of any other sizes or types of networks that facilitate communication of data between computers.

The first computer 110 may comprise a personal digital assistant, personal computer, laptop, desktop, workstation, server, or any other machine with a network adapter such as primary adapter 120 and a standby adapter 130. The first computer 110 may include both a primary adapter 120 and a standby adapter 130 and may comprise an input-output (IO) bus 165 and an IO bus 190. IO bus 165 and IO bus 190 may be redundant buses, primary and secondary buses, parallel buses, or different types of buses with distinct, primary functions. In the present embodiment, IO bus 165 and IO bus 190 both connect to the primary adapter 120 and standby adapter 130 to facilitate failover.

The second computer 170 may also comprise a personal digital assistant, personal computer, laptop, desktop, workstation, server, or any other machine with the standby adapter 180. Note that the phrase “standby adapter” is used herein to describe the relationship of the adapters with the primary adapter 120 for the purposes of failover but such adapters may have a distinct, primary function until called upon to take over functionality of the primary adapter 120. Consequently, failover may proceed within a computer or between a first computer and a remote computer. The present embodiment includes only two standby adapters. However, other embodiments may comprise any number of standby adapters within the first computer 110 and in other computers connected to network 160.

In many embodiments, the primary adapter 120 may failover to the standby adapter 130 in the first computer 110. In additional embodiments, the primary adapter 120 may failover to the standby adapter 180 in the remote second computer 170. For example, these adapters may comprise an iSCSI adapter or a Fibre Channel adapter.

The primary adapter 120, the standby adapter 130, and the standby adapter 180 may comprise network adapters also termed NICs (network interface cards). Connecting between a computer 110 and a network 160, these network adapters may transmit and receive data via the network 160. To provide uninterrupted network services, the standby adapter 130 and the standby adapter 180 may monitor viability of the primary adapter 120 and may instantaneously take over the primary adapter 120 in response to a failure of the primary adapter 120 or an instruction or other indication to take over the role of the primary adapter 120 such as an indication that the primary adapter 120 will be disabled due to a scheduled or unexpected maintenance event. For example, the adapters may comprise a TOE adapter (TCP/IP offload engine adapter). More specifically, a TOE adapter may offload an entire TCP/IP stack which is crucial to preserving efficacy of high performance networks such as a 10 Gigabit Ethernet network.

Furthermore, the primary adapter 120 may comprise a primary adapter memory 125, the standby adapter 130 may comprise a standby adapter memory 135, and the standby adapter 180 may comprise a standby adapter memory 185. In numerous embodiments, copying the primary adapter memory 125 of the failing primary adapter 120 to the standby adapter memory 135 of the standby adapter 130 or to the standby adapter memory 185 of the standby adapter 180 may expedite TCP/IP offload adapter failover by preserving TCP/IP stack and connection information thus sustaining network integrity.

The primary adapter 120 may communicate within the first computer 110 via the IO bus 165. In the event that the IO bus 165 fails, failover options may include failover to a standby adapter on a different IO bus 190 as well as failover to a standby adapter 180 in a remote second computer 170.

In further embodiments, failover may take place on a different server such as a failover server. In other words, an IO bus problem may render a server unavailable in which case software may automatically begin using a standby server. For example, high performance systems may provide multiple servers in different locations with assigned functions to takeover in case of failure in a network thus creating a safety net of servers available to take over some or all the responsibilities of a failing server. For example, supporting a web site with two separate servers prevents users from detecting glitches because they are redirected from the primary website server to the standby server with another executing copy of the web site. With respect to failover pertaining to an adapter, the preferred design may provide failover to a standby adapter in the same server and on the same bus, thus utilizing DMA through the IO bus.

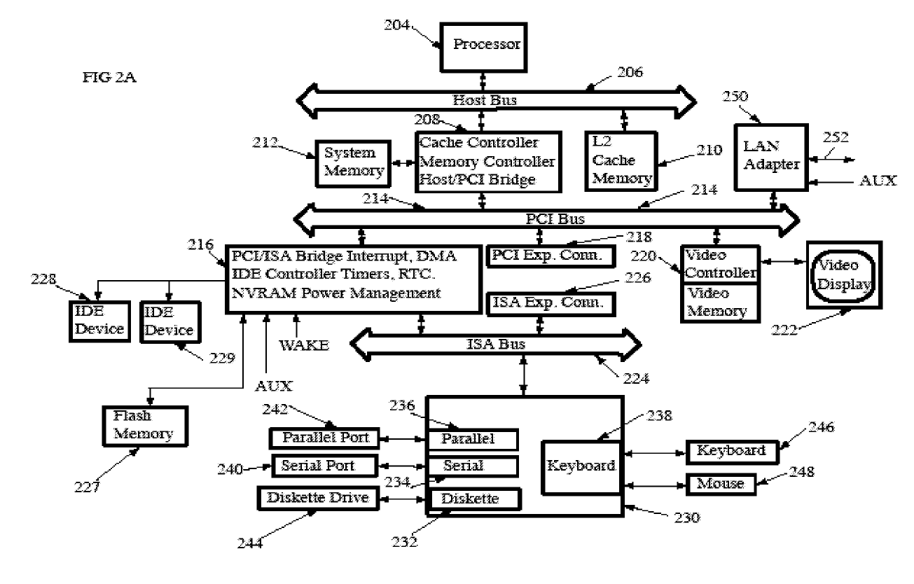

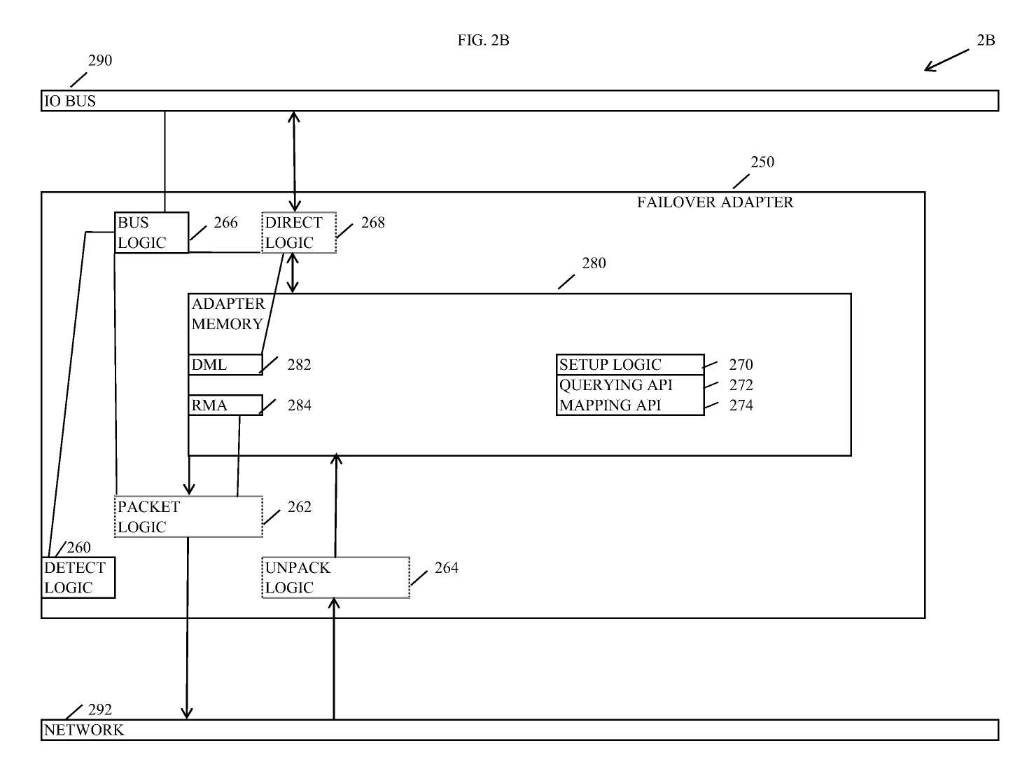

Turning now to FIG. 2A, there is shown a block diagram of an embodiment of certain components of a personal computer 202 including a failover adapter 250. The personal computer 202 may include a system CPU or processor 204 connecting directly to a high speed host bus 206. In some embodiments, the personal computer 202 may comprise multiple CPUs.

A first system core logic chipset 208 and L2 cache memory 210 may also connect to the host bus 206. The first core logic chipset 208 may include a memory control unit, an L2 cache controller and a peripheral component interconnect (PCI) bridge. The memory control unit may further connect to a volatile random access memory (RAM) 212. The RAM memory 212 may comprise one or more memory modules. The memory control unit, or memory controller, may include the logic for mapping addresses to and from the processor 204 to particular areas of RAM 212. The cache controller may operatively couple to the L2 cache memory 210.

Continuing, the PCI bridge within chipset 208 may provide an interface between the host bus 206 and a PCI bus 214. A second core chipset 216 and a plurality of PCI expansion connectors 218 for receiving PCI bus compatible peripheral cards may connect to the PCI bus 214. One such peripheral card may be a video controller 220. The video controller 220 may include video memory and may couple to the monitor or video display terminal 222.

The chipset 216 may contain a bus control and timing unit, a plurality of timers, an interrupt controller, a direct memory access (DMA) unit, nonvolatile CMOS RAM (also herein referred to as NVRAM), a CMOS real-time clock (RTC), Flash memory interface, a PCI/ISA bridge, an integrated drive electronics (IDE) controller, and power management circuitry. The PCI/ISA Bridge may provide an interface between the PCI bus 214 and an optional feature or expansion bus such as the Industry Standard Architecture (ISA) bus 224. A plurality of ISA expansion connectors 226 for receiving ISA adapter cards (not shown) may connect to the ISA bus 224. ISA adapter cards may pluggably connect to the ISA expansion connectors 226 and may provide additional devices or memory for the personal computer 202.

Attached to the chipset 216 is a flash memory (FM) module or chip 228. Flash memory module 227 may contain code that personal computer 202 may execute. The flash memory 227 may be any type or size of flash memory. In other embodiments, another type of non-volatile memory may provide the functionality of flash memory 227 such as an electrically erasable programmable read only memory (EEPROM) module or chip. The IDE controller provides for the attachment of IDE compatible storage devices such as the fixed disk drive 228 and CD-ROM drive 229.

The real-time clock (RTC) of block 216 may be used for time of day calculations and the NVRAM of block 216 may be used to store system configuration data. That is, the NVRAM of block 216 may contain values that describe the present configuration of the personal computer 202. For example, NVRAM of block 216 may contain information describing the type of fixed disk or diskette, the list of IPL devices set by a user and the sequence to be used for a particular power on method, the type of display, the amount of memory, time, date, etc. Furthermore, these data may be stored in NVRAM of block 216 whenever a special configuration program, such as configuration/setup, is executed. The purpose of the configuration/setup program is to store values characterizing the configuration of the system to NVRAM of block 216.

Power management logic of block 216 may change the personal computer 202 between various power states (e.g., off, suspend and normal operating states). For example, the circuitry of block 216 also may include a timer that is configurable by a user to expire after a predetermined period of time, often referred to a time to power on function. When the timer expires, the circuitry of block 216 such as a service processor or a chip or chipset may cause the personal computer 202 to change from the off state to the normal operating state.

Coupled to the ISA bus 224 may be a multi-function I/O controller 230 such as, for example, a National Semiconductor PC87307. The I/O controller 230 may contain a variety of I/O adapters and other components such as the diskette adapter 232, serial adapter 234, a parallel adapter 236 and keyboard controller 238. The diskette adapter 232 provides the interface to the diskette drive 244. The serial adapter 234 may comprise an external port connector 240 for attachment of external devices such as modems (not shown). The parallel adapter 236 may comprise an external port connector 242 for attachment of external devices such as printers (not shown). The keyboard controller 238 may serve as the interface for the keyboard connector 246 and the mouse connector 248.

A communication subsystem 250 may couple to either the PCI bus 214 or ISA bus 224 for allowing personal computer 202 to communicate (i.e., transmit/receive data) with a remote computer or server over a LAN via a connection or link. The communication subsystem 250 may be, for example, a LAN adapter or a LAN connection. Communication subsystem 250 may also be known as a network interface card (NIC).

In multiple embodiments, the LAN adapter 250 may function as a failover adapter. In other words, the failover adapter 250 may monitor adapter viability and may initiate failover upon detecting adapter degradation. More specifically, the failover adapter 250 may instantaneously copy adapter memory to failover adapter memory. As a result, the failover adapter 250 may instantaneously takeover the failing adapter thus preserving system integrity.

In some embodiments, LAN adapter 250 may comprise more than one network adapters, one being used as a primary adapter and another as a standby adapter such as the primary adapter 120 and standby adapter 130 in FIG. 1.

In various embodiments, the LAN adapter 250 may failover to a remote LAN adapter located elsewhere on the network. For example the LAN adapter 250 may serve as a primary adapter while the remote LAN adapter may function as a standby adapter. In this failover scenario, a failing LAN adapter 250 may copy TCP/IP stack and connection information to the remote standby adapter. Upon storing the primary adapter memory in the standby adapter memory, the remote standby adapter may take over the primary LAN adapter 250. In further embodiments, the LAN adapter 250 may maintain a copy of the TCP/IP stack and connection information in the memory of the remote, standby adapter and the standby adapter can take over functionality of the primary adapter as soon as the standby adapter recognizes that problem with the primary adapter occurred or receives an instruction or other indication that the standby adapter should take over functionality of the primary adapter.

Communication subsystem 250 may include a Media Access Controller (MAC), which serves as an interface between a shared data path (e.g., a media independent interface as described below) and the PCI bus 214 (or ISA bus 224 if communication subsystem 250 were connected to the ISA bus 224). The MAC may perform a number of functions involved in the transmission and reception of data packets. For example, during the transmission of data, the MAC may assemble the data to be transmitted into a packet with address and error detection fields. Conversely, during the reception of a packet, the MAC may disassemble the packet and perform address checking and error detection. In addition, the MAC may perform encoding/decoding of digital signals transmitted over the shared path and may perform preamble generation/removal as well as bit transmission/reception.

The communication subsystem 250 may further comprise a physical layer and a media independent interface (MII), which is a local bus between the MAC and the physical layer. The MII may comprise a specification of signals and protocols which formalize the interfacing of a 10/100/1000 Mbps Ethernet MAC, for example, to the underlying physical layer. The physical layer may receive parallel data from the MII local bus and may convert it to serial data for transmission over cable. The physical layer may include auto-negotiation logic that, in one embodiment, determines the capabilities of the server 252, advertises its own capabilities to the server 252, and establishes a connection with the server 252 using the highest performance common connection technology.

Turning now to FIG. 2B, there is shown a detailed embodiment of the LAN adapter 250 that is a failover adapter. The LAN adapter 250 may expedite offload adapter failover. In an optimal failover environment, the LAN adapter 250 may instantaneously take over a failing adapter. In other environments, the LAN adapter 250 may take over functionality of a failing adapter after some time period.

During failover, a Copy Logic may copy a content of a primary adapter memory to a standby adapter memory at a memory address stored in a memory location. In various embodiments, Copy Logic may comprise a Direct Logic 268, a Packet Logic 262, or an Unpack Logic 264. In several embodiments, Copy Logic may couple to the IO bus. In multiple embodiments, Copy Logic may comprise part of an adapter such as a chipset on an adapter, part of a chipset on an adapter card, or one or more chipsets. In other embodiments, Copy Logic may comprise part of a computer platform coupled to the IO bus rather that on the LAN adapter 250.

A Setup Logic 270 may store a network address in a memory location of an adapter memory 280. Also, Setup Logic 270 may set up both a Destination Memory Location (DML) hardware register 282 and a Remote MAC Address (RMA) hardware register 284 in the adapter memory 280. In various embodiments, Setup Logic 270 may comprise part of an adapter such as firmware on an adapter or a chipset. In various embodiments, Setup Logic 270 may comprise a microcontroller with firmware, code to execute on the CPU, or a state machine. In alternative embodiments, Setup Logic 270 may comprise a driver logic for use by a system administrator. In several embodiments, Setup Logic 270 may couple to the IO bus. In multiple embodiments, Setup Logic 270 may comprise part of the LAN adapter 250 such as a chipset on the LAN adapter 250, part of a chipset on the LAN adapter 250, or one or more chipsets. In other embodiments, Setup Logic 270 may comprise part of a computer platform coupled to the IO bus 290. In such embodiments, Setup Logic 270 may handle failover for more than one primary adapters coupled with IO bus 290.

Furthermore, Setup Logic 270 may comprise an application programming interface (API). More specifically, Setup Logic 270 may comprise a Querying API 272 and a Mapping API 274. The Querying API 272 may query a MAC address for a standby adapter such as standby adapter 130 or standby adapter 180 in FIG. 1. In some embodiments, the Querying API 272 may query a MAC address for more than one standby adapter so that a secondary standby adapter can take over the functionality of LAN adapter 250 if the primary standby adapter is unavailable for some reason. In several embodiments, a priority may be assigned to standby adapters by an administrator and the priority may define the order in which standby adapters should be selected for the failover. In other embodiments, the priority may be set up as a policy such that the Setup Logic 270 can select the standby adapter for the failover. For instance, the policy may indicate that the standby adapters with the fastest bus or network connections have a higher priority than standby adapters with slower bus or network connections. Thus, the policy would indicate that a standby adapter on the same IO bus as the primary adapter would have a higher priority than an adapter on a slower IO bus or an adapter in connected via a TCP/IP connection.

Mapping API 274 may map a memory address for one or more standby adapters. Setup Logic 270 may comprise the Querying API 272 for querying a MAC address for writing to the RMA hardware register 284 as well as a Mapping API 274 for mapping a memory address for writing to the DML hardware register 282. Once setup is complete, the DML hardware register 282 may store a memory address for the standby adapter(s) and the RMA hardware register 284 may store a MAC address for the standby adapter(s). For example, the APIs may comprise firmware, software, or other code. In some embodiments, the APIs may comprise hardware such as a state machine in addition to or in place of the code.

In many embodiments, adapter memory 280 may include the RMA hardware register 284 and the DML register 282. Other embodiments may use general memory rather than a hardware register. In some embodiments, the specific memory location may be selected whenever the adapter is installed rather than being dedicated prior to the installation. In alternative embodiments, memory locations within the adapter may comprise selected or determined, physical or logical memory locations rather than utilizing separate hardware registers. For example, a memory location may be setup at a factory during manufacture of the LAN adapter 250. Furthermore, a memory location may be setup as a plug in card by selecting a memory location and allocating it to be an RMA or DML register.

In multiple embodiments, a Detect Logic 260 may monitor adapter viability by monitoring the adapter heartbeat. More specifically, a heartbeat is a periodic signal which an adapter may generate to indicate that it is robust as opposed to failing. Upon detecting a faltering heartbeat, Detect Logic 260 may notify Assess Logic 266 to determine the method of copying the adapter memory.

In several embodiments, an Assess Logic 266 may reside on the failover adapter 250 and may monitor status of the IO bus 290. In particular, Assess Logic 266 may assess IO bus viability. To elaborate, an operative IO bus 290 may permit DMA copying of adapter memory whereas an inoperative IO bus 290 may prohibit DMA copying. Therefore, Assess Logic 266 may determine the method of copying adapter memory during failover. In sum, copying of the adapter memory may occur expeditiously via DMA copying utilizing an operative IO bus 290 or may require transport through the network 260 when the IO bus 290 is unavailable. In many embodiments, the network may be used to copy to another adapter card within the same computer.

With an operative IO bus 290, Assess Logic 266 may notify Direct Logic 268 to commence copying adapter memory via DMA such as DMA of block 216 in FIG. 2A. With an operative IO bus 290, a Direct Logic 268 may DMA adapter memory at the location stored in the DML hardware register 282. In a few embodiments, Direct Logic 268 may reside on the IO bus 290 rather than on the failover adapter 250.

Direct Logic 268 may comprise a processor termed a DMA engine which may access memory directly. Without the DMA engine, the more elaborate route of accessing memory involves sending a request to access the memory to the CPU which may then retrieve the contents of the memory to return to the requesting device.

On the other hand, an inoperative IO bus 290 may exclude DMA necessitating transfer of adapter memory through the network 292. More specifically, a Packet Logic 262 may fragment the adapter memory 280, may pack the fragmented memory into network packets, and may send the network packets through the network 292 to the MAC address stored in the RMA hardware register 284. In many embodiments, the failover adapter 250 may include a Packet Logic 262.

When the network packets arrive, Unpack Logic 264 may unpack the network packets. In addition, Unpack Logic 264 may store the unpacked fragmented memory into the adapter memory 280 at the MAC address stored in the RMA hardware register 284.

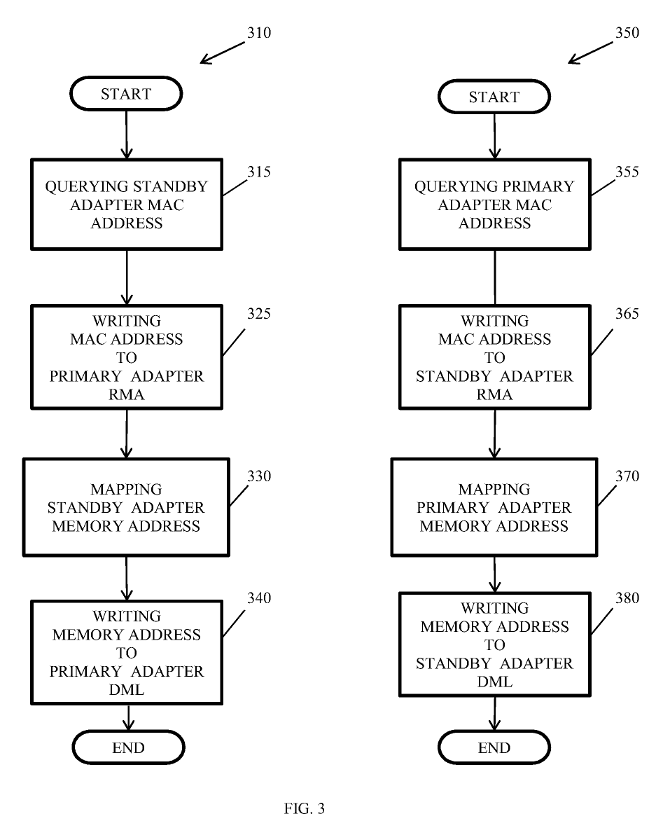

FIG. 3 depicts flowcharts 310 and 350 illustrating setup of a Destination Memory Location (DML) hardware register and a Remote MAC Address (RMA) hardware register. Flowchart 310 provides perspective of a primary adapter whereas flowchart 350 provides perspective of a standby adapter.

Flowchart 310 illustrates setting up the RMA hardware register and the DML hardware register on the primary adapter. Flowchart 310 may begin with querying a MAC address on the standby adapter (element 315) for writing to the RMA hardware register on the primary adapter (element 325). In several embodiments, a system administrator may utilize the Querying API to query the MAC address on the standby adapter for writing to the RMA hardware register on the primary adapter. Continuing, the DML hardware register may be setup by mapping a memory address on the standby adapter (element 330) for writing to the DML hardware register on the primary adapter (element 340). In some embodiments, the system administrator may employ the Mapping API to map the memory address on the standby adapter for writing to the DML hardware register on the primary adapter.

Flowchart 350 illustrates setting up the RMA hardware register and the DML hardware register on the standby adapter. Flowchart 350 may begin with querying a MAC address on the primary adapter (element 355) for writing to the RMA hardware register on the standby adapter (element 365). In some embodiments, a system administrator may employ the Querying API to query the MAC address on the primary adapter for writing to the RMA hardware register on the standby adapter. Also, the DML hardware register may be setup by mapping a memory address on the primary adapter (element 370) for writing to the DML hardware register on the standby adapter (element 380). In other embodiments, the system administrator may utilize the Mapping API to map the memory address on the primary adapter for writing to the DML hardware register on the standby register. In further embodiments, both the RMA hardware register and the DML hardware register may be set up automatically without intervention by a system administrator.

Upon completion of the hardware register setup, both the primary adapter and the secondary adapter may include an RMA hardware register and a DML hardware register. In other words, the setup may create a total of four hardware registers with both the primary adapter and the secondary adapter including both an RMA hardware register and a DML hardware register.

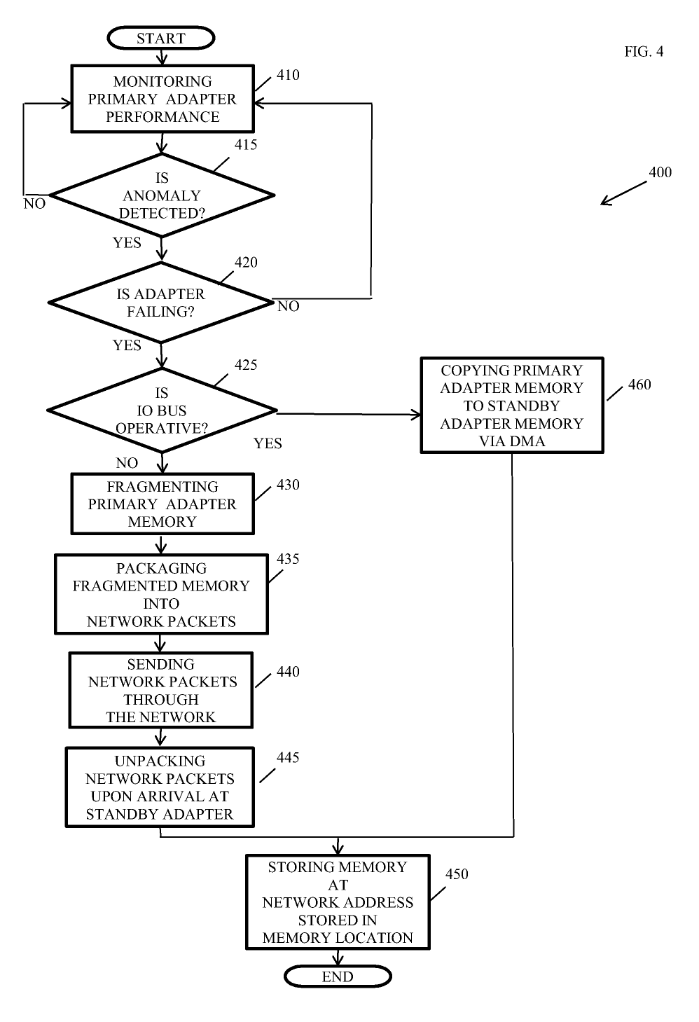

FIG. 4 depicts a flowchart 400 illustrating copying of primary adapter memory to standby adapter memory. When viability of a primary adapter is compromised, rapid copying of primary adapter memory to standby adapter memory can preserve network integrity.

Detect Logic may monitor primary adapter performance (element 410). In some embodiments, evaluating primary adapter performance may comprise monitoring a heartbeat. In other embodiments, assessing primary adapter performance may comprise evaluating primary adapter activity.

Upon detecting an anomaly in primary adapter performance (element 415), Detect Logic may ascertain whether the aberration is incidental or indicative of primary adapter failure (element 420). With an inconsequential deviation, Detect Logic continues monitoring primary adapter performance (element 410). On the other hand, detection of primary adapter degradation necessitates initiation of adapter failover. Upon discerning primary adapter deterioration (element 420), Detect Logic may notify Assess Logic to ascertain whether the IO bus is operative (element 425).

Assess Logic may assess IO bus status which may determine the method of copying primary adapter memory to standby adapter memory. An operative IO bus may permit direct memory access (DMA) which is the swiftest avenue available for copying primary adapter memory to standby adapter memory. With an operative IO bus, Assess Logic may output a signal notifying Direct Logic to proceed with copying primary adapter memory to standby adapter memory via DMA (element 460) for storage at a network address stored in a memory location (element 450). In some embodiments, the memory address stored in the DML hardware register may indicate the location for storing the copied adapter memory (element 480) on the standby adapter. For example, setting up the DML hardware register may store this memory address as illustrated in FIG. 3.

Alternatively, if the IO bus is inoperative, adapter memory may travel through the network. More specifically, Detect Logic may notify Packet Logic to fragment the primary adapter memory (element 420), package the fragmented memory into network packets (element 425), and send the network packets through the network (element 430). In other embodiments, the memory the contents to transfer to the standby adapter may fit in a single packet. In further embodiments, the contents of the memory in the standby adapter may be copied to the standby adapter and periodically updated so that during the failover procedure, changes to the primary adapter memory are copied to the standby adapter. In such embodiments, the changes may fit in one or more packets.

Upon arrival of the network packet(s) at the standby adapter, Unpack Logic may recognize and intercept the network packets, unpack the network packets (element 435) and store the unpacked fragmented primary adapter memory in the standby adapter memory (element 440) at the network address stored in the memory location. In some embodiments, Unpack Logic may store the network packets at the location stored in the RMA hardware register during the RMA hardware register setup as illustrated in FIG. 3.

In multiple embodiments, an assortment of DMA copying techniques may accomplish DMA adapter copying. Memory may offload to a dedicated DMA engine or to an embedded device. Nonetheless, the particular technique Direct Logic may utilize is irrelevant to achieving the transfer of primary adapter memory to standby adapter memory for the purposes of expediting adapter failover. Similarly, Packet Logic may employ various procedures for fragmenting adapter memory for packaging into network packets while Unpack Logic may utilize a variety of techniques for packing the memory into the standby adapter.

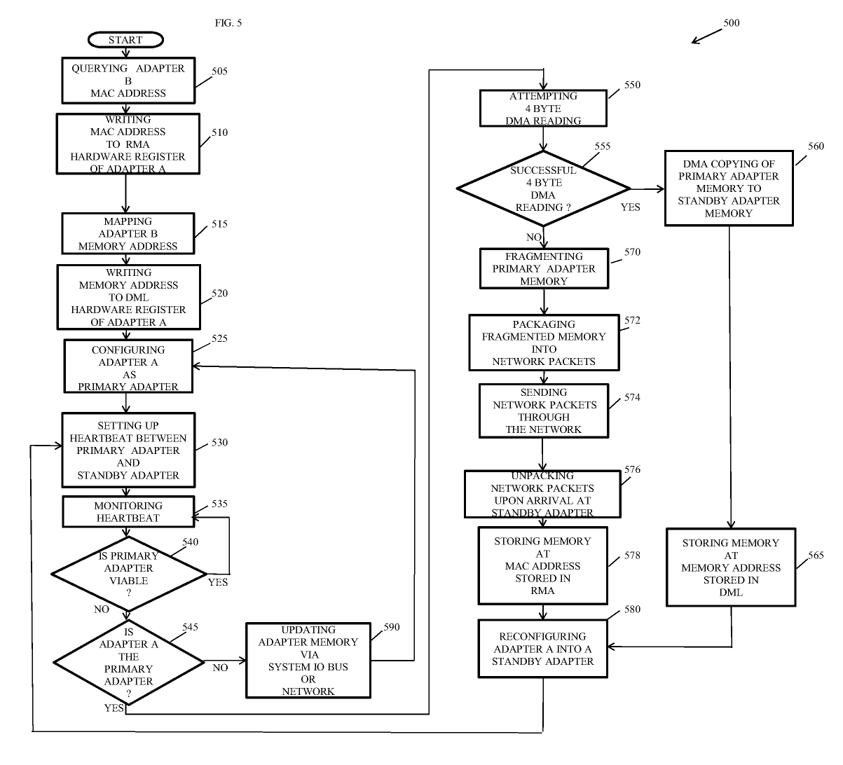

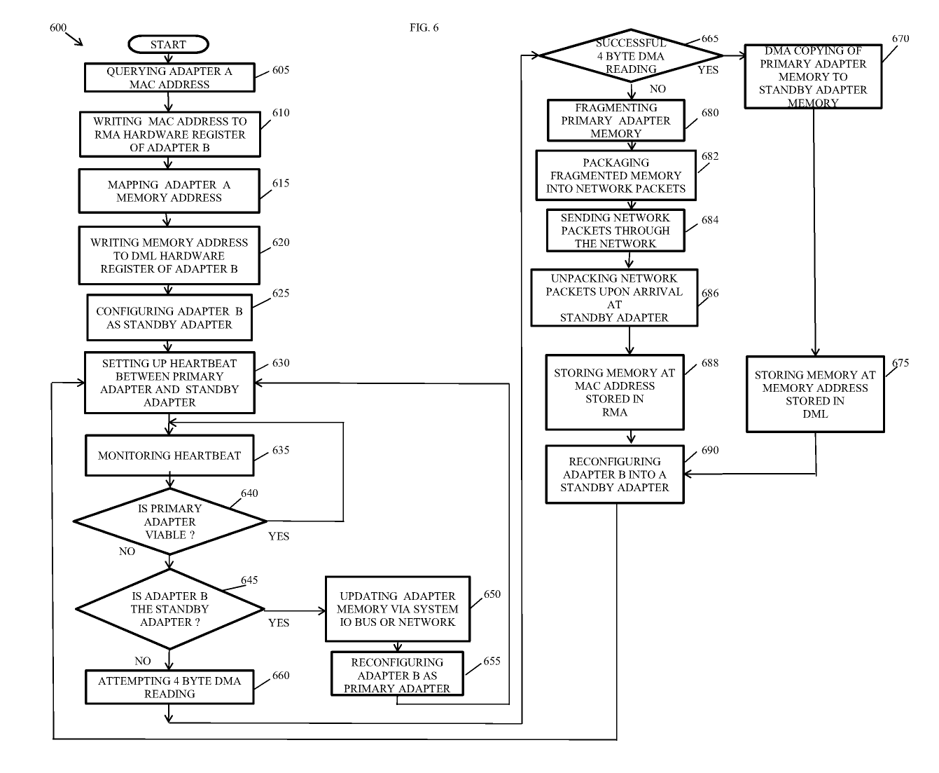

FIG. 5 and FIG. 6 depict flowcharts illustrating an adapter failover system. FIG. 5 provides perspective of an Adapter A whereas FIG. 6 provides perspective of an Adapter B. The adapter failover system of FIG. 5 and FIG. 6 may incorporate both the setup of the DML hardware register and the RMA hardware register as shown in FIG. 3 as well as the copying of primary adapter memory to standby adapter memory as illustrated in FIG. 4. Consequently, four hardware registers may be setup on the two adapters including a DML hardware register and an RMA hardware register on Adapter A as well as a DML hardware register and an RMA hardware register on Adapter B.

FIG. 5 depicts flowchart 500 illustrating an adapter failover system from the perspective of Adapter A. Flowchart 500 may begin with querying a MAC address of Adapter B (element 505) for updating the RMA hardware register (element 510). In some embodiments, a system administrator may use a Querying API to query the MAC address on Adapter B for writing to the RMA hardware register on Adapter A. In addition, mapping a memory address of Adapter B (element 515) may provide a memory address for updating the DML hardware register (element 520). In further embodiments, the system administrator may employ a Mapping API to map the memory address on Adapter B for writing to the DML hardware register on Adapter A.

Upon configuring Adapter A as the primary adapter (element 525), a heartbeat may be setup between the primary adapter and the standby adapter (element 530). Monitoring the heartbeat (element 535) may provide information regarding viability of the primary adapter (element 540).

Cessation of the heartbeat indicates the primary adapter is no longer viable. When Adapter A is configured as the primary adapter (element 545), Direct Logic may attempt DMA reading of 4 bytes of data from the memory address stored in the DML hardware register (element 550). Whether the reading is successful (element 555) may correspond to whether the IO bus is operative. Further, an operative IO bus may permit the swiftest avenue of adapter memory copying via DMA. A successful reading indicates that Direct Logic may DMA (element 560) primary adapter memory to standby adapter memory. Direct Logic may store the copied memory at the memory address stored in the DML hardware register (element 565).

Continuing, Adapter A may reconfigure into a standby adapter (element 580), and a heartbeat may be setup between the primary adapter and the standby adapter (element 530). Monitoring the heartbeat (element 535) may indicate whether the primary adapter is viable (element 530). Because Adapter A is now the standby adapter rather than the primary adapter (element 545), adapter memory may update either via the system IO bus or the network (element 590). Upon completion of the update, Adapter A may configure as the primary adapter (element 525).

An unsuccessful 4 byte DMA reading attempt (element 555) may correspond to an inoperative IO bus preventing DMA copying. In the alternative, Packet Logic may fragment the primary adapter memory (element 570), may pack the fragmented memory into network packets (element 572), and may send the network packets through the network (element 574).

Unpack Logic may unpack the network packets upon their arrival at the standby adapter (element 576) for storing at the MAC address stored in the RMA hardware register (element 578). Continuing, Adapter A may reconfigure into a standby adapter (element 580), and the heartbeat may be setup between the primary adapter and the standby adapter (element 535).

In multiple embodiments, a variety of methods may detect adapter failure. In several embodiments, the system administrator may employ HACMP to detect adapter degradation. For example, HACMP may detect loss of connectivity as an indication of adapter failure. In addition, adapter failure detection methods may range from a fully automated process to a partially automated process requiring confirmation from a system administrator. Upon determining that the adapter is degrading, the system administrator may continue with the failover method of choice.

671 FIG. 6 depicts flowchart 600 illustrating an adapter failover system from the perspective of Adapter B. Flowchart 600 may begin with querying Adapter A's MAC address (element 605) for updating the RMA hardware register (element 610) as well as mapping Adapter A's memory address (element 615) for updating the DML hardware register (element 620). In some embodiments, a system administrator may employ a Querying API to query the MAC address on Adapter A for writing to the RMA hardware register on Adapter B while utilizing a Mapping API to map the memory address on Adapter A for writing to the DML hardware register on Adapter B.

Upon configuring Adapter B as the standby adapter (element 625), a heartbeat may be setup between the primary adapter and the standby adapter (element 630). Monitoring the heartbeat (element 635) may indicate whether the primary adapter is viable (element 640). In particular, heartbeat cessation may correlate with a failing primary adapter.

When Adapter B is configured as the standby adapter (element 645), the adapter memory of Adapter B may update either via the IO bus or the network (element 650). Upon completion of the update, Adapter B may reconfigure into a primary adapter (element 655). After setting up the heartbeat between the primary and standby adapters (element 630), heartbeat monitoring (element 635) may indicate viability of the primary adapter (640).

Adapter B may represent the primary adapter rather than the standby adapter (element 645). Consequently, Direct Logic may attempt 4 byte DMA reading (element 660). A successful reading indicates that Direct Logic may copy primary adapter memory to standby adapter memory via DMA (element 670). Direct Logic may store the copied memory at the memory address stored in the DML hardware register (element 675).

Also, Adapter B may reconfigure into a standby adapter (element 690), and a heartbeat may be setup between the primary adapter and the standby adapter (element 625).

However, an unsuccessful reading indicates the IO bus may be inoperative thus excluding DMA. In alternative embodiments, Packet Logic may fragment the primary adapter memory (element 680), may pack the fragmented memory into network packets (element 682), and may send the network packets through the network (element 684).

In further embodiments, Unpack Logic may unpack the network packets upon their arrival at the standby adapter (element 686) for storing the fragmented memory at the MAC address stored in the RMA hardware register (element 688). Continuing, Adapter B may reconfigure into a standby adapter (element 690), and a heartbeat may be setup between the primary adapter and the standby adapter (element 625).

In many embodiments, various methods may indicate adapter degradation. In some embodiments, a heartbeat lapse may indicate adapter failure. For example, HACMP (high availability cluster multiprocessing) may detect whether data may transmit. In particular, inability to transmit data may indicate adapter degradation. Regardless of the detection method utilized, the system administrator may proceed with various offload adapter failover routines.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments may take the form of an entirely hardware embodiment, an entirely software embodiment, or other embodiments containing both hardware and software elements. One embodiment may have implementation in software, which may include but is not limited to firmware, resident software, microcode, etc.

Furthermore, embodiments may take the form of a computer program product accessible from a computer-usable or computer-readable medium providing program code for use by or in connection with a computer or any instruction execution system. For purposes of this description, a computer-usable or computer-readable medium may be any apparatus that may contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium may include a semiconductor or solid state memory, magnetic tape, a removable computer diskette, a random access memory (RAM), a read-only memory (ROM), a rigid magnetic disk, and an optical disk. Examples of optical disks may include compact disk-read only memory (CD-ROM), compact disk-read/write (CD-R/W), and DVD.

A data processing system suitable for storing and/or executing program code may include at least one processor coupled directly or indirectly to memory elements through an IO bus. The memory elements may include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) may couple to the system either directly or through intervening I/O controllers. Network adapters may also couple to the system to enable the data processing system to couple to other data processing systems or remote printers or storage devices through intervening private or public networks. Modems, cable modem, and Ethernet adapter cards are just a few of the currently available types of network adapters.

The logic as described above may be part of the design for an integrated circuit chip. A graphical computer programming language may create the chip design. A computer storage medium (such as a disk, tape, physical hard drive, or virtual hard drive such as in a storage access network) may store the chip design. If the designer does not fabricate chips or the photolithographic masks used to fabricate chips, the designer may transmit the resulting design by physical means (e.g., by providing a copy of the storage medium storing the design) or electronically (e.g., through the Internet) to such entities, directly or indirectly. The stored design may be converted into the appropriate format (e.g., GDSII) for the fabrication of photolithographic masks, which typically include multiple copies of the chip design in question that are to be formed on a wafer. The photolithographic masks may be utilized to define areas of the wafer (and/or the layers thereon) to be etched or otherwise processed.

The resulting integrated circuit chips may be distributed by the fabricator in raw wafer form (that is, as a single wafer that has multiple unpackaged chips), as a bare die, or in a packaged form. In the latter case, the chip may be mounted in a single chip package (such as a plastic carrier, with leads that are affixed to a motherboard or other higher level carrier) or in a multichip package (such as a ceramic carrier that has either or both surface interconnections or buried interconnections). In any case, the chip may integrate with other chips, discrete circuit elements, and/or other signal processing devices as part of either (a) an intermediate product, such as a motherboard, or (b) an end product. The end product may be any product that may include integrated circuit chips, ranging from toys and other low-end applications to advanced computer products having a display, a keyboard or other input device, and a central processor.

The embodiments shown and described in the detailed description and the drawings are to be taken merely as examples. It is intended that the following claims be interpreted broadly to embrace all variations of the example embodiments disclosed. Although the present disclosure and some of its advantages have been described in detail for some embodiments, it should be understood that various changes, substitutions, and alterations may be made herein without departing from the spirit and scope of the disclosure as defined by the appended claims. Although specific embodiments may achieve multiple objectives, not every embodiment falling within the scope of the attached claims will achieve every objective. Moreover, the scope of the present application is not intended to be limited to the particular embodiments of the process, device, manufacture, composition of matter, means, methods, and steps described in the specification.

As one of ordinary skill in the art will readily appreciate from this disclosure, processes, devices, manufacture, compositions of matter, means, methods, or steps presently existing or later to be developed that perform substantially the same function or achieve substantially the same result as the corresponding embodiments described herein may be utilized. Accordingly, the appended claims are intended to include within their scope such processes, devices, manufacture, compositions of matter, means, methods, or steps.

What is claimed is:

1 An apparatus comprising:
a Setup Logic coupled with a primary adapter memory of a primary adapter to interconnect a computer to a network; the Setup Logic to store a network address in a memory location of the primary adapter memory and in a memory location of a standby adapter memory of a standby adapter; and
a Copy Logic coupled with the primary adapter memory, the Copy Logic to copy, during failover, a content of the primary adapter memory to the standby adapter memory at the network address stored in the memory location, wherein the content comprises a portion of the primary adapter memory with connection information for establishing connections in the standby adapter memory.

2. The apparatus of claim 1, wherein the connection information comprises TCP/IP (Transmission Control Protocol/Internet Protocol) stack and connection information.

3. The apparatus of claim 1, further comprising an Assess Logic coupled with the Copy Logic, the Assess Logic to determine a method of copying the content of the primary adapter memory to the standby adapter memory.

4. The apparatus of claim 3, further comprising a Detect Logic coupled with the Assess Logic, the Detect Logic to notify the Assess Logic to begin failover upon detecting deterioration of the primary adapter.

5. The apparatus of claim 1, wherein the Copy Logic comprises a Direct Logic to copy, by direct memory access, the content of the primary adapter memory to the standby adapter memory at the network address.

6. The apparatus of claim 1, wherein the Copy Logic comprises a Packet Logic to fragment the content of the primary adapter memory, package the fragmented memory into a set of network packets, and send the set of network packets through the network to the standby adapter.

7. The apparatus of claim 6, wherein the Copy Logic further comprises an Unpack Logic to recognize, unpack, and store the set of network packets in the standby adapter memory at the network address.

8. The apparatus of claim 1, further comprising a Destination Memory Location (DML) hardware register and a Remote MAC Address (RMA) hardware register for storing the network address.

9. The apparatus of claim 8, wherein the Setup Logic further comprises a Mapping API (application programming interface) to map a memory address for writing to a DML hardware register and a Querying API to query a MAC address for writing to an RMA hardware register.

10. A method comprising:
detecting, by a Detect Logic, deterioration of a primary adapter connected to a network to establish connections with other devices;
notifying, by the Detect Logic, an Assess Logic to begin failover in response to detecting deterioration of the primary adapter;
determining, by the Assess Logic, a method of copying a content of the primary adapter memory to a standby adapter memory of a standby adapter; and
copying, by a Copy Logic, the content of the primary adapter memory to the standby adapter memory at a network address stored in a memory location, wherein the content comprises a portion of the primary adapter memory with connection information to establish connections in the standby adapter memory.

11. The method of claim 10, wherein the connection information comprises TCP/IP (Transmission Control Protocol/Internet Protocol) stack and connection information.

12. The method of claim 10, wherein copying comprises DMA direct memory access) copying, by a Direct Logic.

13. The method of claim 10, wherein copying comprises fragmenting the content of the primary adapter memory, packaging the fragmented memory into a set of network packets, and sending the set of network packets through the network to the standby adapter, by a Packet Logic.

14. The method of claim 13, wherein copying further comprises recognizing and unpacking the set of network packets and storing them in the standby adapter at the network address, by an Unpack Logic.

15. The method of claim 10, wherein the Assess Logic determines the method of copying by attempting DMA (direct memory access) copying, wherein a successful attempt corresponds to copying by DMA copying and an unsuccessful attempt corresponds to copying by fragmenting the content of the primary adapter memory, packaging the fragmented memory into a set of network packets, sending the set of network packets through the network, recognizing and unpacking the set of network packets, and storing the content of the primary adapter memory in the standby adapter memory at the network address.

16. The method of claim 10, further comprising setting up, by a Setup Logic, the memory location for storing the network address; wherein the Setup Logic sets up a primary adapter hardware register and a standby adapter hardware register by querying a MAC address of the standby adapter for writing to an RMA (Remote MAC Address) hardware register of the primary adapter; by mapping a memory address of the standby adapter for writing to a DML (Destination Memory Location) hardware register of the primary adapter; by querying a MAC address of the primary adapter for writing to an RMA hardware register of the standby adapter; and by mapping a memory address of the primary adapter for writing to a DML hardware register of the standby adapter.

17. A computer program product for resetting an automatic shut-off module, the computer program product comprising:
a computer usable medium having computer usable program code embodied therewith, the computer usable program code comprising:
computer usable program code configured to perform operations, the operations comprising:
detecting, by a Detect Logic, deterioration of a primary adapter connected to a network to establish connections with other devices;
notifying, by the Detect Logic, an Assess Logic to begin failover in response to detecting deterioration of the primary adapter;
determining, by the Assess Logic, a method of copying a content of the primary adapter memory to a standby adapter memory of a standby adapter; and
copying, by a Copy Logic, the content of the primary adapter memory to the standby adapter memory at a network address stored in a memory location, wherein the content comprises a portion of the primary adapter memory with connection information to establish connections in the standby adapter memory.

18. A system comprising:
a standby adapter, with a standby adapter memory; and
a primary adapter to interconnect a computer to a network, having a primary adapter memory, the primary adapter to failover to the standby adapter in response to primary adapter deterioration, by copying a content of the primary adapter memory to the standby adapter memory, wherein the content comprises a portion of the primary adapter memory with connection information for establishing connections in the standby adapter memory.

19. The system of claim 18, wherein the standby adapter interconnects a remote computer to the network.

20. The system of claim 18, wherein the primary adapter and the standby adapter interconnect the computer to the network.
